(19) United States
(12) Patent Application Publication
(10) Pub. No.: US 2017/0036685 A1
(43) Pub. Date: Feb. 9, 2017

(54) Cart for Transporting Sport Fence Panels

(71) Applicant: Michael Edward Spence, Vinton, VA (US)

(72) Inventor: Michael Edward Spence, Vinton, VA (US)

(21) Appl. No.: 15/226,706

(22) Filed: Aug. 2, 2016

Related U.S. Application Data
(60) Provisional application No. 62/282,466, filed on Aug. 3, 2015.

(51) Int. Cl. B62B 3/10; B60D 1/145; B62B 5/06

(52) U.S. Cl. CPC B62B 3/108; B62B 5/06; B60D 1/145

(57) ABSTRACT

A cart is provided for hauling sport fence panels for setting up a temporary outfield boundary for softball and baseball fields. The cart has laterally extending fence panel supports sized to haul enough fence panels to set up an entire field in one trip with the cart. The cart is manufactured in a modular form such that it can be readily and easily disassembled to make it shippable to a customer in a small, compact package. The assembled cart can be moved about a ball field using a lawn tractor, ATV, UTV or other vehicle as is found in grounds-keeping. The cart is light enough, even when loaded with panels, to be hand towed about a field.

### CROSS REFERENCE TO RELATED APPLICATIONS

This application claims priority to U.S. Provisional Application 62/282,466, filed Aug. 3, 2015, entitled “Cart for Transporting Sport Fence Panels” which is incorporated herein by reference in its entirety.

### BACKGROUND OF THE INVENTION

This invention relates to devices used for collecting and transporting fence panels used to form a barrier in sporting fields. More particularly, in softball and baseball fields, fence panels are used to define an outfield fence at a distance particular to the specific sport and age level playing, and according to the association rules for that sport. These fence panels are typically lightweight panels made of poly-vinyl-chloride (PVC). They have a size of approximately eight to ten feet long and three to five feet high. A woven mesh surface covers a frame to aid in making the panels lightweight yet resistant to blowing over in a wind. A typical fence panel of the type used with the present invention can be seen in U.S. Pat. No. 7,793,397, the specification of which is hereby incorporated by reference in its entirety.

Typically, it takes around 40 panels to form a continuous outfield fence on a ball-field. Transporting these panels to and from the outfield has presented a challenge to ball-field crews. Much labor is needed to haul each individual panel, or small groups of panels, to and from the field. The device of the present invention reduces this labor many times.

### BRIEF SUMMARY OF THE INVENTION

According to the invention, a cart that can haul multiple panels is provided that is lightweight and easily moved about a playing field. The cart of the present invention can haul enough panels so that one trip across the outfield can result in the construction of the temporary fence, or alternatively, in the tearing down and hauling away of the fence when it is not needed. In a preferred embodiment of the invention, a cart is provided which is easily and quickly broken down into its few component parts so as to allow it to be shipped to customers in a lightweight, compact package.

It is therefore an object of the invention to provide a device that can haul twenty or more fence panels at one time to reduce the number of trips needed to and from the ball-field when setting up a temporary outfield fence. It is another object of the present invention to provide a device that will significantly reduce the amount of labor needed to set up a temporary outfield fence for a baseball or softball field. It is another object of the invention to provide a lightweight cart that can haul approximately 40 or more panels, yet can be towed by a lawn tractor, tractor, ATV, UTV, or other towing vehicle as is commonly used in ball field maintenance, or can even be hand towed by a groundskeeper. A further object of the invention is to construct a lightweight cart that can be simply and easily broken down into its component parts to allow for efficient shipping to customers. These and other objects will be realized with reference to the attached figures and detailed description.

### BRIEF DESCRIPTION OF THE DRAWINGS

The invention will be further described in connection with the accompanying drawing, in which:

FIG. 1 is a perspective view of a cart according to the invention, and

FIG. 2 is an exploded view of the cart of FIG. 1, showing its modular components.

### DETAILED DESCRIPTION

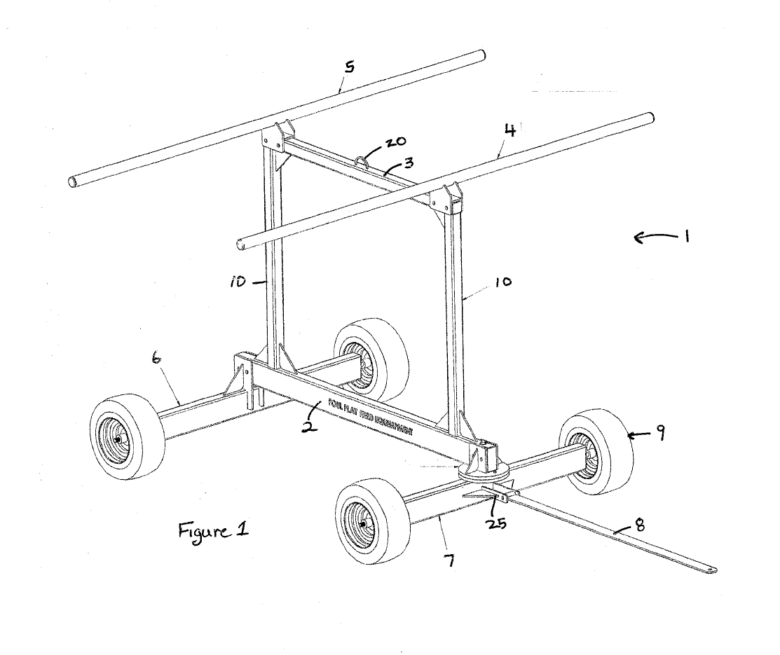

As shown in FIG. 1, cart 1 is used for transporting sports fence panels, such as those shown in U.S. Pat. No. 7,779,397, to and from the outfield of baseball and softball fields. These fence panels are placed across the outfield from the 1^{st} base foul line to the 3^{rd} base foul line in a continuous arc at a predetermined distance from home plate, as prescribed by the various association rules relevant to that particular sport. Cart 1 makes it easier, and reduces the labor, for one or more grounds-keepers to set up the field accordingly.

In a preferred embodiment, cart 1 comprises a frame made up of several detachably connected assemblies. Wheels 9 of cart 1 are removably attached to axles on lower frame members 6 and 7. Front frame member 7 has a tongue or drawbar 8 removably attached thereto by common means such as bolt and nut. Front frame member 7 also has a lower horizontal frame member 2 attached at its center. Lower horizontal frame member 2 extends rewardly to it attachment to the center of rear frame member 6. Attached to lower horizontal frame member 2 is upper horizontal frame member 3. Upper frame member 3 has latterly extending support members 4 and 5. Latterly extending support members 4 and 5 extend a length sufficient to support a desired number of fence panels. The typical length of cart 1 is approximately eight feet, although the actual length may be determined by the length of fence panels being transported. Latterly extending support members 4 and 5 extend both to the left side and to the right side of upper frame member 3, allowing the fence panels to be carried on both sides of cart 1.

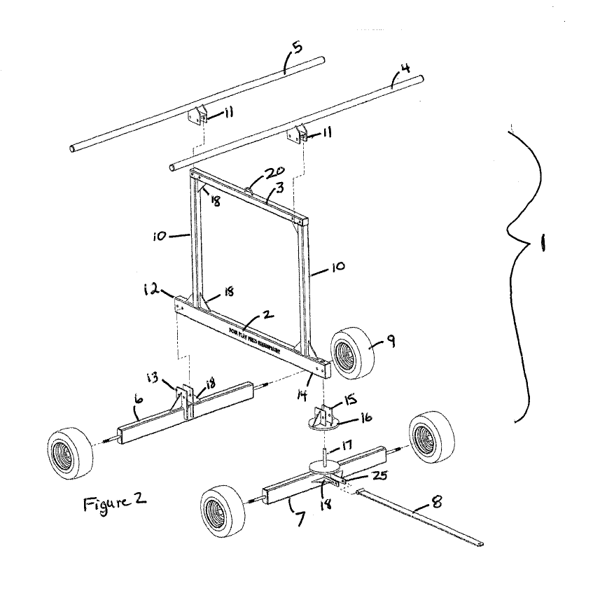

Referring now to the exploded view of FIG. 2, cart 1 is shown in its disassembled, modular form. In its disassembled, modular form, it can be seen that cart 1 may be boxed and shipped to a customer in a package that is limited in size to the thickness of wheels 9 and to the length and width of upper and lower frame members 3 and 2, or to the length of latterly extending support members 4 and 5, whichever is greater. By manufacturing cart 1 in this modular form, it is more easily broken down into its modular components for ease in packaging and shipping.

Assembly of cart 1 is accomplished by attaching wheels 9 to the axles on front frame member 7 and rear frame member 6. Then, lower horizontal frame member 2 has a rearward projecting member 12 which is engaged in corresponding bracket 13 on rear frame member 6, and fastened thereto using appropriate fasteners, such as bolt and nut. Lower frame member 2 has a forward projecting member 14 which similarly is engaged in corresponding bracket 15 with appropriate fasteners. Bracket 15 is attached to pivoting member 16 which is pivotingly engaged on pin 17, which extends upwardly from front frame member 7, through pivoting member 16, and finally passes through forward projecting member 14 on lower frame member 7. Tongue 8 telescopingly engages corresponding bracket 25 on front frame member 7, through which an appropriate fastener (not shown) is placed. Upper horizontal frame member 3 is affixed to lower horizontal frame member 2 via vertical support members 10. Vertical support members 10 may be permanently affixed to upper and lower horizontal frame members 3 and 2, such as by welding, or they may be separate components that may be attached to frame members 2 and 3 using removable fasteners, such as bolts and nuts. Finally, fence support members 4 and 5 may be removably attached to upper horizontal frame member 3 by brackets 11 and suitable fasteners. As shown, angled reinforcing gussets 18 can be added at the corners of horizontal frame members 2 and 3 and vertical support members 10, to further strengthen these members. Gussets 18 may be added at the intersections of any members that require extra reinforcement.

In operation, cart 1 may be loaded with sport fence panels of the type shown in U.S. Pat. No. 7,793,397 by placing multiple panels on both sides of cart 1. Upper horizontal frame member 18 shown in FIG. 9 of U.S. Pat. No. 7,793,397 may be placed over fence support members 4 and 5 and rest thereon. Once fully loaded with fence panels, a bungee cord, not shown, or other means for lashing the fence panels to cart 1 may be attached at loop 20 on upper frame member 3 and passed around the fence panels to thereby secure them to cart 1 during transport to and from the playing field. Alternatively, fence support members 4 and 5 may be angled upwardly from their center attachment to upper frame member 3 to bias the fence panels toward the center of the cart 1 by gravity, thus preventing them from falling off the cart during transport. Cart 1 may be towed to and from the playing field via tongue 8 attached to a towing motor vehicle, such as a lawn tractor, tractor, ATV, UTV, or the like, not shown, or may simply be towed by hand by a person, not shown.

Though the invention has been described with reference to specific figures and embodiments, it is understood that various changes and modifications may be made without deviating from the scope and spirit of the invention, and the invention should only be limited by the appended claims.

I claim:

1) A sports fence panel hauling cart comprising:
a front and a rear frame member, each of said front and rear frame members having axles attached at distal ends thereof;
a wheel attached to each of said axles;
a lower horizontal frame member, extending between and attached at an approximate center of said front frame member and said rear frame member;
an upper horizontal frame member spaced vertically above and attached to said lower horizontal frame member by a pair of vertical support members;
at least one fence panel support member, said at least one fence panel support member attached to said upper horizontal frame member and extending laterally therefrom;
a tongue pivotally attached to said front frame member for attaching to a means for towing said cart.

2) The sport fence panel hauling cart of claim 1, wherein the front frame member is pivotally attached to the lower horizontal frame member.

3) The sport fence panel hauling cart of claim 1, wherein said at least one fence panel support member comprises two fence panel support members.

4) The sport fence panel hauling cart of claim 3, wherein said two fence panel support members extend laterally substantially equal distances to each side of the cart.

5) The sport fence panel hauling cart of claim 1 wherein the cart is sized to carry enough fence panels to completely set up a playing field.

6) The sport fence panel hauling cart of claim 1 wherein the cart may be towed by a motor vehicle.

7) The sport fence panel hauling cart of claim 1 wherein the cart may be towed by hand.

8) The sport fence panel hauling cart of claim 1, wherein said at least one fence panel support member has a center section attached to said upper horizontal frame member, said at least one fence panel support member having two distal ends, wherein said two distal ends are angled upwardly relative to said center section.

9) The sport fence panel hauling cart of claim 1, wherein the cart is manufactured in modular form so that the cart is easily disassembled for packaging and shipping.
